(19) United States
(12) Patent Application Publication
(10) Pub. No.: US 2024/0327280 A1
(43) Pub. Date: Oct. 3, 2024

(54) MANUFACTURING METHOD FOR GLASS SUBSTRATE AND DISC-SHAPED GLASS SUBSTRATE

(71) Applicant: HOYA CORPORATION, Shinjuku-ku, Tokyo (JP)

(72) Inventors: Shuhei AZUMA, Hung Yen Province (VN); Toshio TAKIZAWA, Yamanashi-shi, Yamanashi (JP)

(21) Appl. No.: 18/574,152

(22) PCT Filed: Jul. 5, 2022
(86) PCT No.: PCT/JP2022/026687

§ 371 Date: Dec. 26, 2023

(30) Foreign Application Priority Data
Jul. 5, 2021 (JP) 2021-111562

(51) Int. Cl. C03C 23/00; C03C 15/02

(52) U.S. Cl. CPC C03C 23/0025; C03C 15/02; C03C 23/007; C03C 2203/52

(57) ABSTRACT

A method for manufacturing a glass substrate includes: flattening a to-be-scribed region extending along a predetermined to-be-scribed line on a surface of a glass blank by irradiating the surface of the glass blank with a first laser beam along the to-be-scribed line; and forming a scribe line along the to-be-scribed line by irradiating the flattened to-be-scribed region with a second laser beam.

### CROSS-REFERENCE TO RELATED APPLICATIONS

This is a U.S. National stage application of International Patent Application No. PCT/JP2022/026687, filed on Jul. 5, 2022, which, in turn, claims priority to Japanese Patent Application No. 2021-111562, filed on Jul. 5, 2021. The entire contents of International Patent Application No. PCT/JP2022/026687 and Japanese Patent Application No. 2021-111562 are hereby incorporated herein by reference.

### BACKGROUND

### Field of the Invention

The present invention relates to a method for manufacturing a glass substrate in which a glass substrate is manufactured through shape processing using a laser beam, and a disk-shaped glass substrate manufactured using the method.

### Background Information

Nowadays, hard disk apparatuses for recording data are used in personal computers, laptops, DVD (Digital Versatile Disc) recording apparatuses, data centers for cloud computing, and the like. A magnetic disk obtained by providing a magnetic layer on a glass substrate for a magnetic disk, which is an annular non-magnetic body, is used in a hard disk apparatus.

A conventional technology for separating an annular glass substrate from a glass blank in such a method for manufacturing a glass substrate for a magnetic disk is known (WO 2020/022510). In this technology, first, a surface of a glass blank from which a glass substrate is to be formed is irradiated with a laser beam along a predetermined ring shape to form defects along the predetermined ring shape. Thus, an outer portion located outside the predetermined ring shape and an inner portion located inside the predetermined ring shape are formed on the surface of the glass blank. Then, the outer portion of the glass blank is heated at a temperature higher than the temperature of the inner portion to cause the outer portion of the glass blank to thermally expand relatively largely compared to the inner portion, so that a gap is formed between the outer portion and the inner portion. As a result, the outer portion and the inner portion of the glass blank can be separated from each other.

### SUMMARY

An object of the present invention is to further improve the technology for manufacturing a glass substrate described in WO 2020/022510 and to provide a technology with which an annular glass substrate can be separated from a glass blank more reliably.

### Solution to Problem

A method for manufacturing a glass substrate according to a first aspect of the present invention includes:
flattening a to-be-scribed region extending along a predetermined to-be-scribed line on a surface of a glass blank by irradiating the surface of the glass blank with a first laser beam along the to-be-scribed line; and
forming a scribe line along the to-be-scribed line by irradiating the flattened to-be-scribed region with a second laser beam.

In the method for manufacturing a glass substrate according to the first aspect of the present invention, the to-be-scribed region may be flattened so as to have a surface roughness Ra of 0.2 μm or less.

In the method for manufacturing a glass substrate according to the first aspect of the present invention, a surface roughness Ra of the surface of the glass blank prior to being irradiated with the first laser beam may be larger than 0.2 μm.

In the method for manufacturing a glass substrate according to the first aspect of the present invention, the to-be-scribed region may be melted or peeled as a result of being irradiated with the first laser beam.

In the method for manufacturing a glass substrate according to the first aspect of the present invention, the to-be-scribed line may form a circle.

The method for manufacturing a glass substrate according to the first aspect of the present invention may include heating a portion outside the scribe line on the glass blank, on which the scribe line has been formed, at a temperature higher than a temperature of a portion inside the scribe line to separate the portion outside the scribe line from the portion inside the scribe line.

In the method for manufacturing a glass substrate according to the first aspect of the present invention, a glass substrate obtained by separating the portion outside the scribe line from the portion inside the scribe line may have two main surfaces and an outer circumferential edge surface,
an outer circumferential edge portion of one of the main surfaces may include a flattened region formed through irradiation with the first laser beam, and
the flattened region may be completely removed by grinding and/or polishing the outer circumferential edge surface of the glass substrate.

A method for manufacturing a glass substrate according to a second aspect of the present invention includes:
preparing a glass blank;
flattening a portion of a main surface of the glass blank including at least a to-be-scribed line to reduce a surface roughness Ra; and
irradiating the flattened surface with a laser beam to form a scribe line.

In the method for manufacturing a glass substrate according to the second aspect of the present invention, the glass blank may have a main surface that has a surface roughness Ra larger than 0.2 μm, and a portion of the main surface may be flattened so as to have a surface roughness Ra of 0.2 μm or less.

In the method for manufacturing a glass substrate according to the second aspect of the present invention, the glass substrate may be a glass substrate for a magnetic disk.

A disk-shaped glass substrate according to a third aspect of the present invention includes:
two main surfaces,
wherein an outer circumferential edge portion of at least one main surface of the two main surfaces includes a flattened region that has a smaller surface roughness Ra than another region of the main surface, and
the flattened region has a width of 5 mm or less in a radial direction and a height within a range from −0.3 to +0.3 mm with respect to the other region of the main surface of the glass substrate.

In the disk-shaped glass substrate according to the third aspect of the present invention, the flattened region may have a surface roughness Ra of 0.2 μm or less, and
the other region of the main surface may have a surface roughness Ra larger than 0.2 μm.

In the disk-shaped glass substrate according to the third aspect of the present invention, there may be a plurality of linear stripes extending in a thickness direction in an outer circumferential edge surface of the glass substrate.

The disk-shaped glass substrate according to the third aspect of the present invention may include: a circular inner hole; and a flattened region extending along an outer edge of the inner hole in one of the two main surfaces.

According to the present invention, it is possible to provide a technology with which an annular glass substrate can be separated from a glass blank more reliably.

### BRIEF DESCRIPTION OF THE DRAWINGS

FIG. 1 is a perspective view of a glass substrate manufactured using a manufacturing method according to an embodiment of the present invention.

FIG. 2 is a flowchart showing the flow of the method for manufacturing a glass substrate according to an embodiment of the present invention.

FIG. 3 is a diagram illustrating irradiation with a laser beam in an outer scribe line formation step.

FIG. 4A is a diagram showing a glass blank on which a to-be-scribed region has been formed as viewed in a direction perpendicular to a main surface, and FIG. 4B is a diagram showing the glass blank on which a scribe line has been formed as viewed in the direction perpendicular to the main surface.

FIG. 5 is a diagram illustrating heating in a first separation step.

FIG. 6 is a diagram illustrating separation through heating in the first separation step.

FIG. 7 is a perspective view of a circular glass blank taken out in the first separation step.

FIG. 8 is a diagram illustrating irradiation with a laser beam in an inner scribe line formation step.

FIG. 9A is a diagram showing a circular glass blank on which a to-be-scribed region has been formed as viewed in a direction perpendicular to a main surface, and FIG. 9B is a diagram showing the circular glass blank on which a scribe line has been formed as viewed in the direction perpendicular to the main surface.

FIG. 10 is a diagram illustrating heating in a second separation step.

FIG. 11 is a diagram illustrating separation through heating in the second separation step.

### DETAILED DESCRIPTION OF THE EMBODIMENTS

### (Annular Glass Substrate)

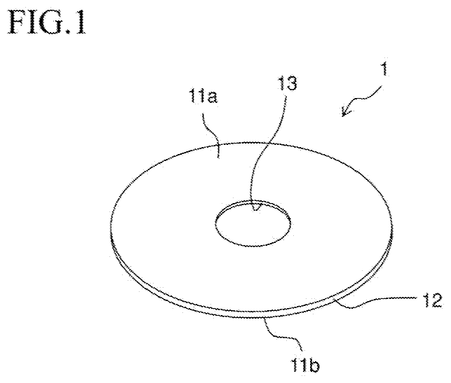

First, an annular glass substrate manufactured using a manufacturing method of this embodiment will be described with reference to FIG. 1. Note that the annular glass substrate is an example of a disk-shaped glass substrate, and the term “disk-shaped glass substrate” used in the present specification encompasses both a disk-shaped glass substrate that does not have an inner hole and an annular glass substrate that has an inner hole.

A glass substrate 1 is a thin annular glass substrate in which a hole is coaxially formed at the center, and is used as a substrate for a magnetic disk, for example. Although there is no limitation on the size of the glass substrate 1, the size is suitable for a magnetic disk with a nominal diameter of 2.5 inches or 3.5 inches, for example. A glass substrate for a magnetic disk with a nominal diameter of 2.5 inches has an outer diameter (diameter) of 55 to 70 mm, a central hole diameter (diameter: also referred to as an “inner diameter”) of 19 to 20 mm, and a thickness of 0.2 to 0.8 mm, for example. A glass substrate for a magnetic disk with a nominal diameter of 3.5 inches has an outer diameter of 85 to 100 mm, a central hole diameter of 24 to 25 mm, and a thickness of 0.2 to 0.8 mm, for example. Note that the term “glass substrate for a magnetic disk” used in the following description also encompasses a disk-shaped or annular glass substrate from which a glass substrate for a magnetic disk is to be formed (i.e., an intermediate body immediately after separation from a glass blank).

The glass substrate 1 includes two main surfaces 11a and 11b opposite to each other, an outer circumferential edge surface 12, and an inner circumferential edge surface 13 that defines the central hole. The main surface 11a is an annular surface whose outer edge and inner edge form two concentric circles. The main surface 11b has the same shape as that of the main surface 11a, and is concentric with the main surface 11a. The outer circumferential edge surface 12 is a surface that connects the outer edge of the main surface 11a and the outer edge of the main surface 11b. The inner circumferential edge surface 13 is a surface that connects the inner edge of the main surface 11a and the inner edge of the main surface 11b. Note that chamfered surfaces may be formed in the above-described connection portions. The chamfered surfaces may have a substantially straight shape or an arc shape in a cross-sectional view. In the case where the chamfered surfaces are formed, the chamfered surfaces are formed at two positions corresponding to the two main surfaces in each of the outer circumferential edge surface and the inner circumferential edge surface. At this time, a side wall surface may be formed between the two chamfered surfaces. The side wall surface has a substantially straight shape or an arc shape in a cross-sectional view, and is substantially perpendicular to the main surfaces. When a magnetic disk is manufactured using the glass substrate 1, magnetic layers are formed on the main surfaces 11a and 11b.

### (Flow of Method for Manufacturing Annular Glass Substrate)

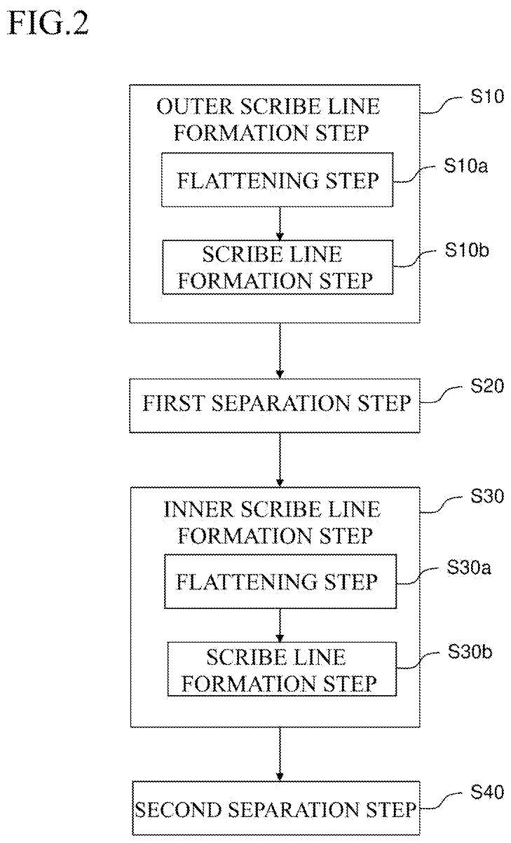

Next, the flow of a method for manufacturing an annular glass substrate according to an example of this embodiment will be described with reference to FIG. 2. The method for manufacturing an annular glass substrate according to this embodiment includes an outer scribe line formation step (S10), a first separation step (S20), an inner scribe line formation step (S30), and a second separation step (S40). The outer scribe line formation step (S10) includes a flattening step (S10a) and a scribe line formation step (S10b), and the inner scribe line formation step (S30) also includes a flattening step (S30a) and a scribe line formation step (S30b).

The outer scribe line formation step (S10) is a step for forming an outer scribe line on a glass blank that is used as a material of the glass substrate 1. In the flattening step (S10a), an outer to-be-scribed region extending along a predetermined outer to-be-scribed line is flattened by irradiating a surface of the glass blank with a first laser beam along the outer to-be-scribed line. In the scribe line formation step (S10b), an outer scribe line is formed along the outer to-be-scribed line by irradiating the flattened outer to-be-scribed region with a second laser beam. In the first separation step (S20), a portion outside the outer scribe line and a portion inside the outer scribe line on the glass blank are separated by heating the portion outside the outer scribe line at a temperature higher than the temperature of the portion inside the outer scribe line. Thus, a circular glass blank is taken out. The inner scribe line formation step (S30) is a step for forming an inner scribe line on the circular glass blank taken out in the first separation step S20. In the flattening step (S30a), an inner to-be-scribed region extending along a predetermined inner to-be-scribed line is flattened by irradiating a surface of the circular glass blank with the first laser beam along the inner to-be-scribed line. In the scribe line formation step (S30b), an inner scribe line is formed along the inner to-be-scribed line by irradiating the flattened inner to-be-scribed region with the second laser beam. In the second separation step (S40), a portion outside the inner scribe line and a portion inside the inner scribe line on the circular glass blank are separated by heating the portion outside the inner scribe line at a temperature higher than the temperature of the portion inside the inner scribe line. Thus, an annular glass substrate is manufactured.

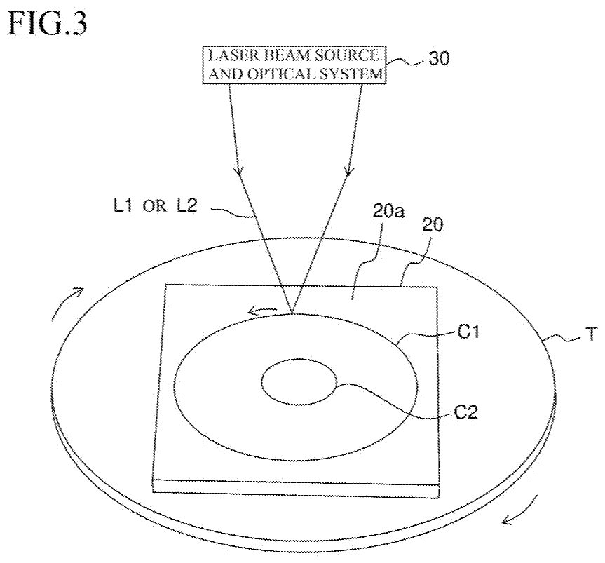

Next, the steps of the method for manufacturing an annular glass substrate according to an example of this embodiment will be described in detail with reference to FIGS. 3 to 11.

### (Outer Scribe Line Formation Step S10)

First, the following describes the outer scribe line formation step (S10).

### (Flattening Step S10a)

In the flattening step (S10a) included in the outer scribe line formation step (S10), a glass blank 20 that is produced in advance and has a rectangular shape or the like is irradiated with a first laser beam L1 as shown in FIG. 3.

Examples of the glass blank 20 used as a material of the glass substrate 1 include glass blanks made of aluminosilicate glass, aluminoborosilicate glass, soda-lime glass, borosilicate glass, and the like. In particular, amorphous aluminosilicate glass and aluminoborosilicate glass can be chemically strengthened as needed and can be used to produce a glass substrate for a magnetic disk having excellent strength and including main surfaces with excellent flatness, and thus can be favorably used. The glass blank 20 is produced by molding molten glass through press molding or slicing a glass ingot, for example, and has a constant thickness. Alternatively, the glass blank 20 may be produced by being cut out from a glass sheet produced using a float method or an overflow downdraw method. It is preferable to apply the present invention to a glass blank 20 produced through press molding, ingot slicing, or the like. One reason for this is that a glass blank produced through press molding, ingot slicing, or the like has larger surface roughness than a glass blank produced using the float method or the overflow downdraw method. When the surface roughness of a glass blank is large, a laser beam may not enter the inside of the glass blank due to being reflected off a surface of the glass blank, for example, and defects may not be formed appropriately. It was found that, in a case where defects are not formed appropriately, even when a portion outside a scribe line on an annular glass substrate is heated at a temperature higher than the temperature of a portion inside the scribe line in the above-described method for manufacturing an annular glass substrate, an appropriate gap may not be formed between the portion outside the scribe line and the portion inside the scribe line, and these portions may not be separated. Therefore, when the present invention is applied to glass blanks 20 produced through press molding, ingot slicing, or the like or glass blanks 20 including a ground surface that has a relatively large surface roughness (e.g., Ra exceeding 0.2 μm), it is possible to stably separate a large number of glass blanks 20 without failure.

A laser beam source and optical system 30 used in the flattening step (S10a) is an apparatus for emitting the first laser beam L1, and examples thereof include a gas laser such as a CO₂ laser. The wavelength of the first laser beam L1 can be set to be within a range from 2 to 11 μm, for example. Regarding the light energy of the first laser beam L1, an average output during the irradiation time is 3 W or more, and the spot diameter is 0.1 to 10 mm, for example.

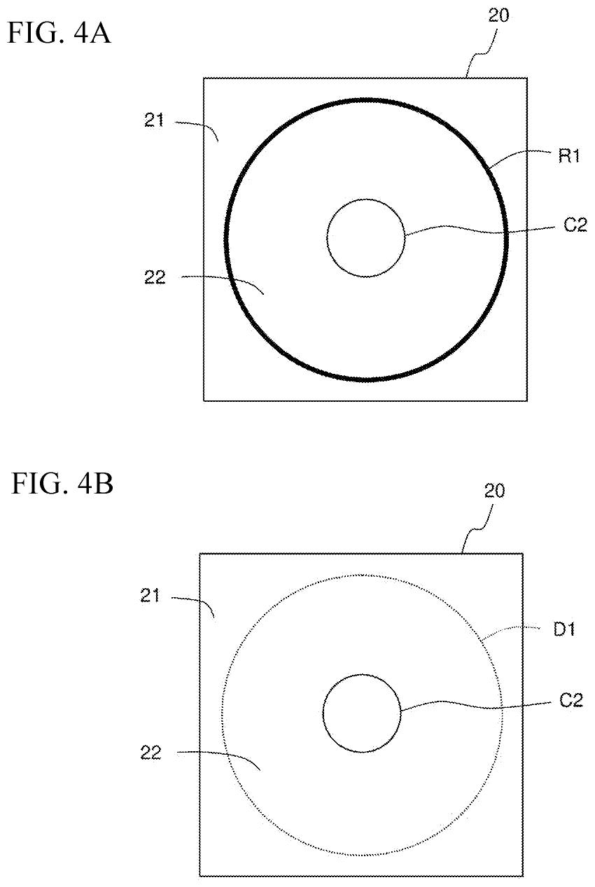

The first laser beam L1 is adjusted as appropriate so as to have a spot diameter of 0.1 to 10 mm, for example, on the surface of the glass blank 20 and moved relative to the glass blank 20 fixed to a stage T while the glass blank 20 is irradiated with the first laser beam L1. For example, the stage T and the glass blank 20 may be rotated about a central axis at a constant speed with an irradiation position of the first laser beam L1 fixed. The first laser beam L1 and/or the glass blank 20 is moved relative to each other at a speed of 0.7 to 140 mm/second, for example. The glass blank 20 is continuously irradiated with the first laser beam L1 along an outer to-be-scribed line C1, which is an imaginary line having a circular shape, for example, on the glass blank 20 in the counterclockwise direction shown by the arrows in FIG. 3. As a result, an outer to-be-scribed region R1 having a constant width (e.g., about 0.1 to 10 mm) in a radial direction and continuously extending along the outer to-be-scribed line C1 on the surface of the glass blank 20 as shown in FIG. 4A is flattened. Here, “being flattened” means that surface roughness Ra is reduced on the order of micrometers (i.e., a reduction in roughness), and a flattened region does not include a shape change caused by a groove or bulge formed with a width of 100 μm or more in a cross-sectional view. The outer to-be-scribed region R1 is a region in which the surface of the glass blank 20 is melted or partially peeled as a result of being irradiated with the first laser beam L1. In the case where the surface is melted, the surface of the glass blank 20 substantially maintains its original height (substantially maintains flatness) or bulges. In the case where the surface is peeled, a groove is formed in the surface of the glass blank 20. These phenomena can be controlled by changing the temperature of the glass blank 20 during irradiation with the first laser beam L1. That is, in a case where the temperature of the glass blank 20 during irradiation with the first laser beam L1 is relatively low, the surface is likely to be peeled. In a case where the temperature is relatively high, the surface is likely to bulge. In a case where the temperature is between the temperatures of these cases, the height of the surface barely changes. Out of these three patterns, the case where the original height of the surface is substantially maintained after the surface is melted is most preferable because irradiation with a second laser beam L2, which will be described later, can be stably performed. The temperature of the glass blank 20 can be controlled by heating the glass blank 20 using a suitable method before and/or during irradiation with the first laser beam L1. For example, a heater may be embedded in the above-described stage T and the glass blank 20 may be brought into contact with the heated stage T to heat the glass blank 20 through heat conduction. Alternatively, the glass blank 20 may be heated in a contactless manner with use of an infrared ray heater such as a halogen lamp heater, a carbon heater, or a sheathed heater, or a CO₂ laser, for example. The outer to-be-scribed region R1 preferably has a surface roughness Ra of 0.2 μm or less. The surface roughness Ra of the outer to-be-scribed region R1 is more preferably 0.1 μm or less. Here, the arithmetic average roughness Ra is a value in accordance with JIS B0601:2001. In order to obtain the arithmetic average roughness Ra, a surface shape of an edge surface of the glass blank 20 is measured in a square evaluation region with a length of 50 μm per side under the following conditions using a laser microscope, for example. A resolution in the thickness direction is preferably 1 nm or less. The observation magnification is 3000× in the present embodiment, but the observation magnification is selected as appropriate within a range from about 1000× to 3000× according to the size of the measurement surface.
Observation magnification: 3000×
Measurement pitch in height direction (Z axis): 0.01 μm
Cut-off value λs: 0.25 μm
Cut-off value λc: 80 μm

### (Scribe Line Formation Step S10b)

Next, in the scribe line formation step (S10b) included in the outer scribe line formation step (S10), an outer scribe line D1 shown in FIG. 4B is formed by irradiating the outer to-be-scribed region R1 flattened in the flattening step (S10a) with the second laser beam L2. For example, the glass blank 20 in which the outer to-be-scribed region R1 has been flattened through irradiation with the first laser beam L1 is moved from the stage T of an apparatus for emitting the first laser beam L1 to a stage T of an apparatus for emitting the second laser beam L2. The outer to-be-scribed region R1 of the glass blank 20 moved to the stage T of the apparatus for emitting the second laser beam L2 is irradiated with the second laser beam L2 to form the outer scribe line D1. Alternatively, a configuration is also possible in which the glass blank 20 in which the outer to-be-scribed region R1 has been flattened through irradiation with the first laser beam L1 is not moved from the stage T of the apparatus for emitting the first laser beam L1, and the scribe line formation step (S10b) is performed on the same stage T. In this case, it is necessary to make adjustments as appropriate so that the laser beam source and optical system 30 used in the flattening step (S10a) and a laser beam source and optical system used in the scribe line formation step (S10b) coincide.

A laser beam source and optical system 30 used in the scribe line formation step (S10b) is an apparatus for emitting the second laser beam L2, and examples thereof include solid lasers such as a YAG laser, a Yb:YAG laser, an Nd:YAG laser, a YVO laser, and an Nd:YVO laser. The wavelength of the second laser beam L2 can be set to be within a range from 1000 nm to 1100 nm, for example. The second laser beam L2 is a pulsed laser beam, and preferably has a pulse width of 10-10 seconds (100 picoseconds) or less. The light energy of the second laser beam L2 can be adjusted as appropriate in accordance with the pulse width and the pulse width repetition frequency, and an average output during the irradiation time is 1 W or more, for example.

It is sufficient that the glass blank 20 is irradiated with the second laser beam L2 using the laser beam source and optical system 30 with the second laser beam L2 being adjusted as appropriate to be focused inside the glass blank 20 or on the surface of the glass blank 20 in the outer to-be-scribed region R1, for example. Through such irradiation with the second laser mean L2, light energy concentrates linearly in the thickness direction of the glass blank 20 at one point in the outer to-be-scribed region R1, and plasma is produced from a portion of the glass blank 20, for example, thus making it possible to form a defect extending in the thickness direction of the glass blank 20. Here, the defect includes a hole formed in the glass blank 20, a crack extending from the hole, and a modified portion of the glass (referred to as a “modified glass portion” hereinafter). The hole may be a through hole that is formed by abrasion so as to extend through the glass blank 20 in the thickness direction of the glass blank 20, or a hole that does not extend through the glass blank 20. The defect may also be a modified glass portion spreading over the entire thickness of the glass blank 20, rather than a hole. The above-described hole or modified portion has a diameter of 1 to 10 μm, for example. It is preferable that these defects extend in a direction substantially orthogonal to a main surface 20a of the glass blank 20 (i.e., intersect therewith at an angle of 85° to 95°). Note that irradiation with the second laser beam L2 may be performed using a method in which self-focusing of a beam based on the Kerr effect is utilized, a method in which a Gaussian-Bessel beam is utilized together with an axicon lens, a method in which a line-focus beam formed using an aberration lens is utilized, or a method using a doughnut beam and a spherical lens, for example. In any case, there is no particular limitation on the conditions of irradiation with the second laser beam L2 as long as a linear defect can be formed as described above.

It is preferable to irradiate the glass blank 20 with the second laser beam L2 in a burst pulse mode in which an optical pulse group composed of pulsed optical pulses continuously generated at a fixed time interval is taken as one unit, and a plurality of optical pulse groups are intermittently generated. In this case, it is also preferable to make light energy of each pulse variable in each optical pulse group. A known technology can be used for such irradiation with a laser beam L. Defects can be efficiently formed using a laser beam in the burst pulse mode.

The second laser beam L2 is moved relative to the glass blank 20 fixed to the stage T while the glass blank 20 is irradiated with the second laser beam L2. For example, the stage T and the glass blank 20 may be rotated about a central axis at a constant speed with an irradiation position of the second laser beam L2 fixed. The outer to-be-scribed region R1 formed on the glass blank 20 in the flattening step (S10a) is intermittently irradiated with the second laser beam L2 at constant periods in the counterclockwise direction shown by the arrows in FIG. 3. In other words, the second laser beam L2 is successively emitted toward a plurality of points spaced apart from each other at constant intervals in the outer to-be-scribed region R1. As a result, a circular outer scribe line D1 is formed by a plurality of defects periodically arranged at constant intervals (e.g., at a pitch of about 3 to 20 μm) along the outer to-be-scribed line C1 on the glass blank 20 as shown in FIG. 4B. Note that the outer to-be-scribed line C1 is an example of a predetermined to-be-scribed line in the present invention, the outer to-be-scribed region R1 is an example of a to-be-scribed region in the present invention, and the outer scribe line D1 is an example of a scribe line in the present invention.

### (First Separation Step S20)

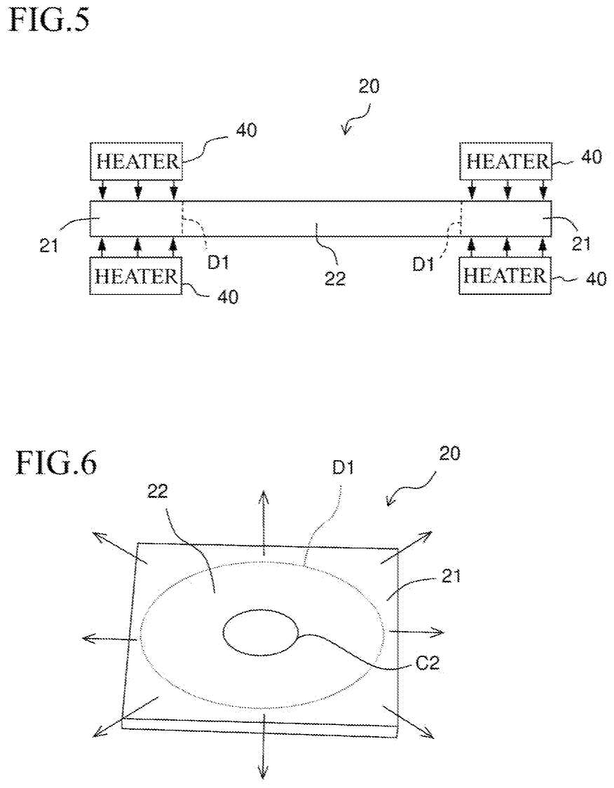

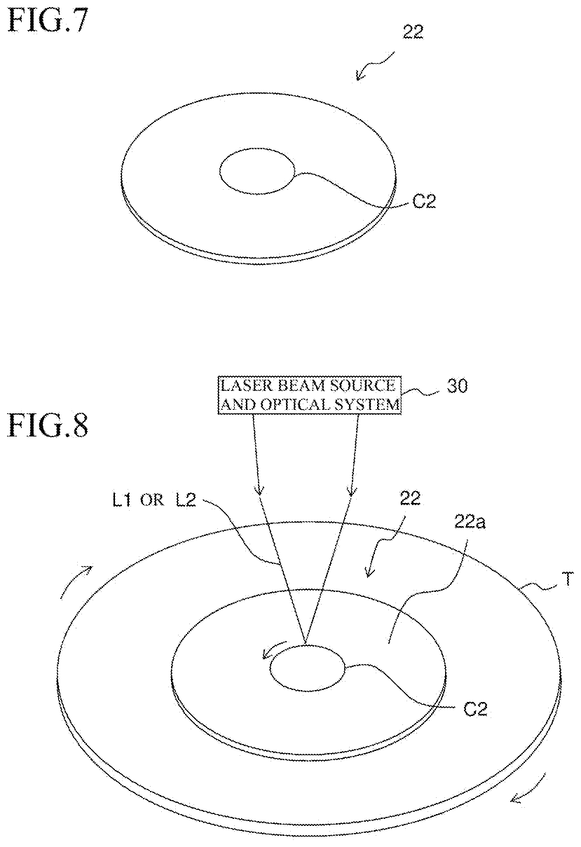

Next, the glass blank 20 on which the outer scribe line D1 has been formed is heated in the first separation step (S20) in order to take out a portion inside the outer scribe line D1 from the glass blank 20. When heating the glass blank 20, heaters 40 are disposed outside the outer scribe line D1, and an outer portion 21 outside the outer scribe line D1 of the glass blank 20 is heated as shown in FIG. 5, for example. Note that it is not preferable to dispose a heater inside the outer scribe line D1. In this case, although an inner portion 22 inside the outer scribe line D1 is also indirectly heated due to heat conduction via a space or heat conduction via the glass blank 20, it can be said that the outer portion 21 of the glass blank 20 is heated at a temperature higher than the temperature of the inner portion 22. Accordingly, the thermal expansion amount of the outer portion 21 of the glass blank 20 can be made larger than the thermal expansion amount of the inner portion 22. As a result, the outer portion 21 of the glass blank 20 thermally expands outward with respect to the outer scribe line D1 as shown in FIG. 6. Specifically, the outer portion 21 thermally expands relative to the inner portion 22, so that the diameter of the inner circumferential edge (inner diameter) of the outer portion 21 is larger than the diameter of the outer circumferential edge (outer diameter) of the inner portion 22. As a result, a gap is formed at an interface between the outer portion 21 and the inner portion 22 of the glass blank 20, thus making it possible to separate the outer portion 21 and the inner portion 22. That is to say, a circular glass blank 22 shown in FIG. 7 can be taken out from the rectangular glass blank 20. An outer circumferential edge surface of the circular glass blank 22 ultimately corresponds to the outer circumferential edge surface 12 of the annular glass substrate 1. Note that “a state in which a gap is formed at an interface between the outer portion 21 and the inner portion 22” encompasses not only a state in which a measurable space is formed throughout the interface between the outer portion 21 and the inner portion 22, but also a state in which surfaces of the outer portion 21 and the inner portion 22 that are opposed to each other are connected neither physically nor chemically even when a measurable space is not obtained. In other words, the state in which a gap is formed at the interface also encompasses a state in which cracks develop at the interface between the outer portion 21 and the inner portion 22, and the outer portion 21 and the inner portion 22 are in contact with each other.

In the case where the surface of the glass blank has been peeled as a result of being irradiated with the first laser beam L1, the outer to-be-scribed region R1 flattened in the flattening step (S10a) may remain as a circular region having a width of 5 mm or less in a direction along the main surface of the circular glass blank 22 and a depth of 0.01 to 0.3 mm with respect to other regions of the main surface, between the main surface and the outer circumferential edge surface of the circular glass blank 22. In such a case, a cross section of the outer to-be-scribed region R1 may have a concave arc shape.

In contrast, in the case where the surface of the glass blank has bulged as a result of being irradiated with the first laser beam L1, the bulge may have a height of 0.01 to 0.3 mm with respect to other regions of the main surface. In such a case, a cross section of the outer to-be-scribed region R1 may have a convex arc shape.

### (Inner Scribe Line Formation Step S30)

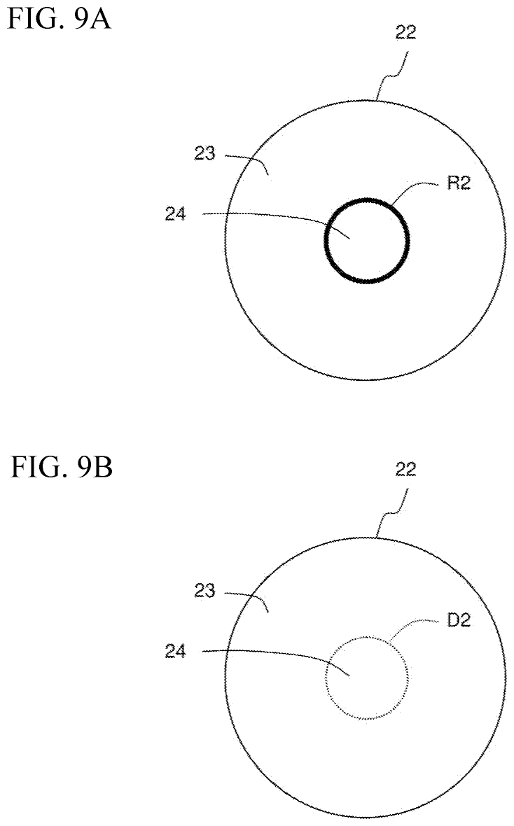

Next, in the flattening step (S30a) included in the inner scribe line formation step (S30), an inner to-be-scribed region R2 is flattened by irradiating the circular glass blank 22 separated in the first separation step (S20) with the first laser beam L1 along an inner to-be-scribed line C2, which is an imaginary line having a circular shape, for example, on a main surface 22a of the circular glass blank 22 as shown in FIGS. 8 and 9A. Next, in the scribe line formation step (S30b) included in the inner scribe line formation step (S30), an inner scribe line D2 shown in FIG. 9B is formed by irradiating the inner to-be-scribed region R2 flattened in the flattening step (S30a) with the second laser beam L2. The flattening step (S30a) and the scribe line formation step (S30b) included in the inner scribe line formation step (S30) only differ from the flattening step (S10a) and the scribe line formation step (S10b) included in the outer scribe line formation step (S10) in the irradiation positions of the laser beams L1 and L2, and are performed using the same laser emitting apparatuses and irradiation methods as those used in the flattening step (S10a) and the scribe line formation step (S10b). Note that the inner to-be-scribed line C2 is an example of the predetermined to-be-scribed line in the present invention, the inner to-be-scribed region R2 is an example of the to-be-scribed region in the present invention, and the inner scribe line D2 is an example of the scribe line in the present invention.

### (Second Separation Step S40)

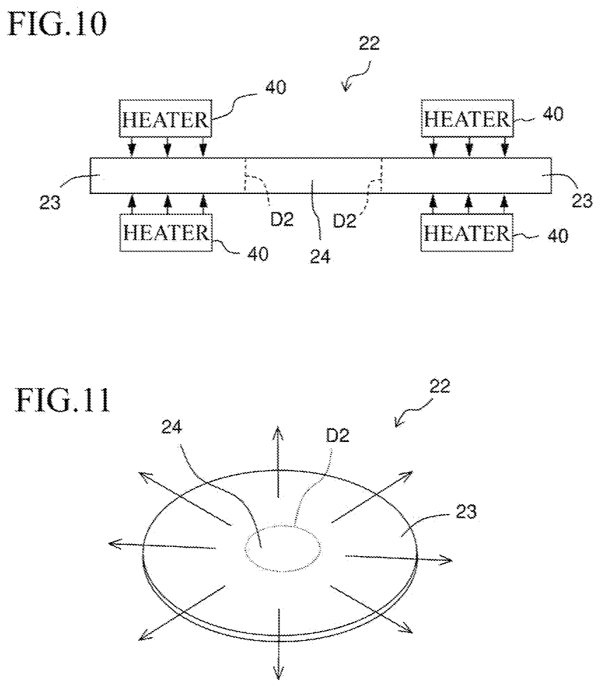

Next, the circular glass blank 22 on which the inner scribe line D2 has been formed is heated in the second separation step (S40) in order to take out a portion inside the inner scribe line D2 from the circular glass blank 22. When heating the circular glass blank 22, heaters 40 are disposed outside the inner scribe line D2, and an outer portion 23 outside the inner scribe line D2 of the circular glass blank 22 is heated as shown in FIG. 10, for example. Note that it is not preferable to dispose a heater inside the inner scribe line D2. In this case, although an inner portion 24 inside the inner scribe line D2 is also indirectly heated due to heat conduction via a space or heat conduction via the circular glass blank 22, it can be said that the outer portion 23 of the circular glass blank 22 is heated at a temperature higher than the temperature of the inner portion 24. Accordingly, the thermal expansion amount of the outer portion 23 of the circular glass blank 22 can be made larger than the thermal expansion amount of the inner portion 24. As a result, the outer portion 23 of the circular glass blank 22 thermally expands outward with respect to the inner scribe line D2 as shown in FIG. 11. Specifically, the outer portion 23 thermally expands relative to the inner portion 24, so that the diameter of the inner circumferential edge (inner diameter) of the outer portion 23 is larger than the diameter of the outer circumferential edge (outer diameter) of the inner portion 24. As a result, a gap is formed at an interface between the outer portion 23 and the inner portion 24 of the circular glass blank 22, thus making it possible to separate the outer portion 23 and the inner portion 24. That is to say, an annular glass substrate 1 from which a central portion has been removed can be produced as shown in FIG. 1 by taking out the inner portion 24 from the circular glass blank 22. An inner circumferential edge surface of the outer portion 23 of the circular glass blank 22 ultimately corresponds to the inner circumferential edge surface 13 of the annular glass substrate 1. Note that “a state in which a gap is formed at an interface between the outer portion 23 and the inner portion 24” in the second separation step (S40) encompasses not only a state in which a measurable space is formed throughout the interface between the outer portion 23 and the inner portion 24, but also a state in which surfaces of the outer portion 23 and the inner portion 24 that are opposed to each other are connected neither physically nor chemically even when a measurable space is not obtained. In other words, the state in which a gap is formed at the interface also encompasses a state in which cracks develop at the interface between the outer portion 23 and the inner portion 24, and the outer portion 23 and the inner portion 24 are in contact with each other.

In the case where the surface of the glass blank has been peeled as a result of being irradiated with the first laser beam L1, the inner to-be-scribed region R2 flattened in the flattening step (S30a) may remain as a circular region having a width of 5 mm or less in a direction along the main surface of the circular glass blank 22 and a depth of 0.01 to 0.3 mm with respect to other regions of the main surface, between the main surface of the circular glass blank 22 and the inner circumferential edge surface of the outer portion 23. In such a case, a cross section of the inner to-be-scribed region R2 may have a concave arc shape.

In contrast, in the case where the surface of the glass blank has bulged as a result of being irradiated with the first laser beam L1, the bulge may have a height of 0.01 to 0.3 mm with respect to other regions of the main surface. In such a case, a cross section of the inner to-be-scribed region R2 may have a convex arch shape.

### (Postprocessing Step)

Postprocessing including an edge surface grinding step, an edge surface polishing step, a main surface grinding step, a main surface polishing step, and the like is also performed after the second separation step (S40), although not illustrated in the figures.

The edge surface grinding step is performed to make the outer diameter and/or the inner diameter of the annular glass substrate 1 closer to a target value by grinding the outer circumferential edge surface 12 and/or the inner circumferential edge surface 13 of the glass substrate. At this time, chamfered surfaces may be formed in the outer circumferential edge surface 12 and/or the inner circumferential edge surface 13 of the annular glass substrate 1 with use of a formed grindstone, for example. It is possible to use a substantially columnar grindstone that has a groove extending along an outer circumferential surface thereof, as the formed grindstone. By pressing an edge surface of the glass substrate against the groove while both the formed grindstone and the glass substrate are rotated, the edge surface can be ground to have an edge surface shape corresponding to the shape of the groove. The edge surface of the glass substrate after chamfered surfaces are formed in the edge surface grinding step may have: two chamfered surfaces that are respectively continuous to the two main surfaces; and a side wall surface between the chamfered surfaces, for example. The chamfered surfaces may have a straight shape or an arc shape protruding outward of the substrate in a cross-sectional view of the substrate taken along a radial direction. The side wall surface may have a straight shape substantially parallel to the thickness direction or an arc shape protruding outward of the substrate in the cross-sectional view. In the cross-sectional view, boundary portions between the side wall surface and the chamfered surfaces may be curved and smoothly connect these surfaces. Note that the edge surface grinding step may be divided into two stages, i.e., rough grinding and precise grinding. For example, the two stages of the edge surface grinding step may be performed using electroplated grinding wheels that differ from each other in the particle size of diamond abrasive particles. Note that the edge surface grinding step may be omitted.

In the edge surface polishing step, the outer circumferential edge surface 12 and/or the inner circumferential edge surface 13 of the annular glass substrate 1 is polished using a brush to be a mirror surface, for example. At this time, a slurry containing minute particles made of cerium oxide, zirconium oxide, or the like acting as loose abrasive particles is used. Polishing the edge surface makes it possible to prevent the occurrence of thermal asperities and ion deposition of sodium, potassium, or the like, which leads to corrosion.

A total allowance in the edge surface grinding step and the edge surface polishing step is preferably determined so as to completely remove an outer circumferential edge-side flattened region and/or an inner circumferential edge-side flattened region of the main surface of the annular glass substrate. In other words, the edge surface grinding step and the edge surface polishing step are preferably performed so as to completely remove the flattened regions described above.

The flattened regions are portions of the flattened outer to-be-scribed region R1 and/or the flattened inner to-be-scribed region R2 (hereinafter “the outer to-be-scribed region R1 and/or the inner to-be-scribed region R2” will also be referred to as “the to-be-scribed region(s) R”) that remain in the separated annular glass substrate. That is, the separated annular glass substrate includes a circular flattened region in an outer circumferential edge portion and/or an inner circumferential edge portion of one of the main surfaces. In other words, each flattened region has an annular shape. In the case where the flattened region has been formed through irradiation with the first laser beam L1, there is residual stress in the surface of the flattened region. The residual stress reduces the strength of the glass, which leads to chipping of the glass substrate. In a case where the flattened region has been formed by polishing only the to-be-scribed region R, the height of the surface in the flattened region is lower than that in other regions (i.e., a step is formed in the main surface), and it may be difficult to uniformly process the entire main surface in the following main surface grinding step and the main surface polishing step. For example, a relatively soft pad is used in the polishing step, and accordingly, the step may not be removed. Such a step is a critical defect in a case where the annular glass substrate is used as a glass substrate for a magnetic disk.

For example, when a circular to-be-scribed region R is formed using the first laser beam L1 with a spot diameter of 1 mm, and an annular glass substrate is separated by irradiating a center line in the width direction of the region R with the second laser beam L2, a flattened region of the separated annular glass substrate has a width of 500 μm in a radial direction. Therefore, in this case, a total allowance in the edge surface grinding step and the edge surface polishing step is preferably set to at least 500 μm (in terms of radius). Note that the allowance can be measured at the center of the edge surface of the glass substrate in the thickness direction. It is also possible to perform only the edge surface grinding step or the edge surface polishing step to completely remove the flattened region.

In the main surface grinding step, the main surfaces 11a and 11b of the annular glass substrate 1 are ground using a double-side grinding device provided with a planetary gear mechanism. The grinding allowance is approximately several μm to several hundred μm, for example. The double-side grinding device includes an upper surface plate and a lower surface plate, and the annular glass substrate 1 is held between the upper surface plate and the lower surface plate. Then, the main surfaces 11a and 11b of the annular glass substrate 1 are ground by moving the annular glass substrate 1 and the surface plates relative to each other. For example, fixed abrasive particles formed by fixing abrasive particles made of diamond or the like in a resin may be attached to surfaces of the surface plates.

In the main surface polishing step, the main surfaces 11a and 11b ground in the main surface grinding step are polished. The polishing allowance is approximately 0.1 μm to 100 μm, for example. The main surfaces 11a and 11b are polished for the purpose of removing flaws and warping that are caused by grinding using fixed abrasive particles and remain on the main surfaces, adjustment of undulations and minute undulations, mirror finishing, roughness reduction, and the like. For example, a polishing liquid containing loose abrasive particles made of cerium oxide, zirconia, silica, or the like can be used to polish the main surfaces. Note that the main surface polishing step may be divided into two or more stages. For example, the main surface polishing step can be divided into first main surface polishing that is rough polishing in which a polishing liquid containing cerium oxide or zirconia is used, and second main surface polishing in which a polishing liquid containing silica is used.

In the above-described manufacturing method according to an aspect of the present invention, the outer to-be-scribed region R1 is flattened by irradiating the glass blank with the first laser beam L1 along the outer to-be-scribed line C1 in the flattening step (S10a) included in the outer scribe line formation step (S10). That is, the surface roughness of the outer to-be-scribed region R1 is made smaller than the surface roughness of portions of the glass blank other than the outer to-be-scribed region R1. In the scribe line formation step (S10b), the outer to-be-scribed region R1 flattened to have a small surface roughness is irradiated with the second laser beam L2. Therefore, the second laser beam L2 enters the inside of the glass blank 20 and defects can be formed more reliably. As a result, an appropriate outer scribe line D1 can be formed, and the outer portion 21 and the inner portion 22 of the glass blank 20 can be separated more reliably in the first separation step (S20).

Furthermore, similarly to the outer scribe line formation step (S10), the inner to-be-scribed region R2 is initially flattened by irradiating the glass blank with the first laser beam L1 along the inner to-be-scribed line C2 in the flattening step (S30a) included in the inner scribe line formation step (S30). That is, the surface roughness of the inner to-be-scribed region R2 is made smaller than the surface roughness of portions of the glass blank other than the inner to-be-scribed region R2. In the scribe line formation step (S30b), the inner to-be-scribed region R2 flattened to have a small surface roughness is irradiated with the second laser beam L2. Therefore, the second laser beam L2 enters the inside of the circular glass blank 22 and defects can be formed more reliably. As a result, an appropriate inner scribe line D2 can be formed, and the outer portion 23 and the inner portion 24 of the circular glass blank 22 can be separated more reliably in the second separation step (S20).

That is, with the manufacturing method according to this aspect of the present invention, it is possible to separate the annular glass substrate 1 from the glass blank 20 more reliably by performing the above-described steps.

### Experiment 1

The flattening step (S10a) was performed on glass blanks 20 with conditions in flattening processing changed as shown in Table 1 below, and then the scribe line formation step (S10b) was performed. The first separation step (S20) was performed under the same conditions on the glass blanks 20 on which the outer scribe line D1 was formed, and an acceptance rate was calculated. The acceptance rate was calculated for each of the glass blanks that were subjected to the flattening processing under respective conditions, by performing the scribe line formation step (S10b) 100 times and counting the number of times separation in the first separation step (S20) was successful. The glass blanks 20 were glass plates having Tg (glass transition temperature) of 750° C., a surface roughness Ra larger than 0.2 μm (about 0.5 μm), a square shape with a length of 110 mm per side, and a thickness of 0.6 mm. Each glass blank 20 was heated to a predetermined temperature before the flattening processing and kept at the predetermined temperature during the flattening processing by using a stage T in which a heater was embedded. The spot diameter of the first laser beam L1 in the flattening step (S10a) was set to 1 mm. In the scribe line formation step (S10b), defects were formed at intervals of 10 μm on a center line in the outer to-be-scribed region R1. A circular glass blank 22 having a diameter (outer diameter) of 98 mm was separated by performing the first separation step (S20).

TABLE 1

| | | Substrate | |
|---|---|---|---|
| | | temperature during | Acceptance |
| | | flattening processing | rate |
| | Flattening step | (° C.) | (%) |
| Ex. 1 | Performed | 25 (room temperature, | 85 |
| | | not heated) | |
| Ex. 2 | Performed | 300 | 97 |
| Ex. 3 | Performed | 600 | 92 |
| Com. Ex. 1 | Not performed | — | 0 |

In Example 1, the flattening step (S10a) was performed at room temperature without heating the glass blank 20. The glass blank subjected to the flattening step (S10a) included a recessed groove having a maximum depth of 0.3 mm or less formed as a result of peeling in the to-be-scribed region R1. After peeled glass fragments were removed by blowing air, the scribe line formation step (S10b) was performed. Ra of the to-be-scribed region R1 was reduced to 0.2 μm or less through the flattening step (S10a).

Conditions in Example 2 were the same as those in Example 1, other than that the temperature of the substrate during the flattening processing was changed to 300° C. After the flattening step (S10a), the to-be-scribed region R1 had no conspicuous peeled portion or bulge, and maintained a height substantially equal to the height of other regions. Ra of the to-be-scribed region R1 was reduced to 0.2 μm or less through the flattening step (S10a).

Conditions in Example 3 were the same as those in Example 1, other than that the temperature of the substrate during the flattening processing was changed to 600° C. After the flattening step (S10a), a protruding bulge having a maximum height of 0.3 mm or less was observed in the to-be-scribed region R1. Ra of the to-be-scribed region R1 was reduced to 0.2 μm or less through the flattening step (S10a).

In Comparative Example 1, the flattening step (S10a) was not performed, and only the scribe line formation step (S10b) was performed.

### Experiment 2

The flattening step (S30a) was performed on circular glass blanks 22 obtained in Experiment 1 described above with conditions in flattening processing changed as shown in Table 2 below, and then the scribe line formation step (S30b) was performed. The second separation step (S40) was performed under the same conditions on the circular glass blanks 22 on which the inner scribe line D2 was formed, and an acceptance rate was calculated. The acceptance rate was calculated for each of the circular glass blanks that were subjected to the flattening processing under respective conditions, by performing the scribe line formation step (S30b) 100 times and counting the number of times separation in the second separation step (S40) was successful. Similarly to Experiment 1 described above, each circular glass blank 22 was heated to a predetermined temperature before the flattening processing and kept at the predetermined temperature during the flattening processing by using a stage T in which a heater was embedded. The spot diameter of the first laser beam L1 in the flattening step (S30a) was set to 1 mm. In the scribe line formation step (S30b), defects were formed at intervals of 10 μm on a center line in the inner to-be-scribed region R2. An annular glass substrate 1 having an outer diameter of 98 mm and an inner diameter of 24 mm was obtained in the second separation step (S40).

TABLE 2

| | | Substrate | |
|---|---|---|---|
| | | temperature during | Acceptance |
| | | flattening processing | rate |
| | Flattening step | (° C.) | (%) |
| Ex. 4 | Performed | 25 (not heated) | 83 |
| Ex. 5 | Performed | 300 | 95 |
| Ex. 6 | Performed | 600 | 90 |
| Com. Ex. 2 | Not performed | — | 0 |

In Example 4, the flattening step (S30a) was performed at room temperature without heating the circular glass blank 22. The glass blank after the flattening step (S30a) included a recessed groove having a maximum depth of 0.3 mm or less formed as a result of peeling in the to-be-scribed region R2. After peeled glass fragments were removed by blowing air, the scribe line formation step (S30b) was performed. Ra of the to-be-scribed region R2 was reduced to 0.2 μm or less through the flattening step (S30a).

Conditions in Example 5 were the same as those in Example 4, other than that the temperature of the substrate during the flattening processing was changed to 300° C. After the flattening step (S30a), the to-be-scribed region R2 had no conspicuous peeled portion or bulge, and maintained a height substantially equal to the height of other regions. Ra of the to-be-scribed region R2 was reduced to 0.2 μm or less through the flattening step (S30a).

Conditions in Example 6 were the same as those in Example 4, other than that the temperature of the substrate during the flattening processing was changed to 600° C. After the flattening step (S30a), a protruding bulge having a maximum height of 0.3 mm or less was observed in the to-be-scribed region R2. Ra of the to-be-scribed region R2 was reduced to 0.2 μm or less through the flattening step (S30a).

In Comparative Example 2, the flattening step (S30a) was not performed, and only the scribe line formation step (S30b) was performed.

### Experiment 3

In Example 7, an annular glass substrate 1 having an outer diameter of 98 mm, an inner diameter of 24 mm, and a thickness of 0.6 mm was obtained by forming an outer circumferential edge surface under the above-described conditions of Example 1 and forming an inner hole under the above-described conditions of Example 4. One main surface 11a of the obtained annular glass substrate 1 included annular flattened regions (surface roughness Ra≤0.2 μm) having a width of 500 μm in a radial direction of the main surface 11a from the outer circumferential edge surface 12 and the inner circumferential edge surface 13, respectively, and a region of the main surface 11a other than the two flattened regions had a surface roughness Ra larger than 0.2 μm. The flattened regions had a depth (maximum value) of 0.3 mm or less with respect to the other region of the main surface 11a.

In Example 8, an annular glass substrate 1 having an outer diameter of 98 mm, an inner diameter of 24 mm, and a thickness of 0.6 mm was obtained by forming an outer circumferential edge surface under the above-described conditions of Example 2 and forming an inner hole under the above-described conditions of Example 5. One main surface 11a of the obtained annular glass substrate 1 included annular flattened regions (surface roughness Ra≤0.2 μm) having a width of 500 μm in a radial direction of the main surface 11a from the outer circumferential edge surface 12 and the inner circumferential edge surface 13, respectively, and a region of the main surface 11a other than the two flattened regions had a surface roughness Ra larger than 0.2 μm. The flattened regions had a height of −0.1 mm to +0.1 mm with respect to the other region of the main surface 11a. Here, the height of the region of the main surface 11a other than the flattened regions is taken as 0, the direction of depth (a case where a groove or the like is formed) is indicated by the minus symbol, and the direction of height (a case where a bulge or the like is formed) is indicated by the plus symbol.

In Example 9, an annular glass substrate 1 having an outer diameter of 98 mm, an inner diameter of 24 mm, and a thickness of 0.6 mm was obtained by forming an outer circumferential edge surface under the above-described conditions of Example 3 and forming an inner hole under the above-described conditions of Example 6. One main surface 11a of the obtained annular glass substrate 1 included annular flattened regions (surface roughness Ra≤0.2 μm) having a width of 500 μm in a radial direction of the main surface 11a from the outer circumferential edge surface 12 and the inner circumferential edge surface 13, respectively, and a region of the main surface 11a other than the two flattened regions had a surface roughness Ra larger than 0.2 μm. Bulges of the flattened regions had a height (maximum value) of 0.3 mm or less with respect to the other region of the main surface 11a.

As described above, the main surfaces 11a on one side of the annular glass substrates 1 obtained in Examples 7 to 9 included the flattened regions (surface roughness Ra≤0.2 μm) having a width of 500 μm from the outer circumferential edge surface 12 and the inner circumferential edge surface 13, respectively. Ra of the regions other than the flattened regions was more than 0.2 μm, and the height of the flattened regions was within the range from −0.3 to +0.3 mm with respect to the other regions of the main surfaces 11a. When the outer circumferential edge surfaces 12 and the inner circumferential edge surfaces 13 of the annular glass substrates 1 obtained in Examples 7 to 9 were observed using a laser microscope, some holes or modified glass portions formed through irradiation with the second laser beam L2 were observed as a plurality of linear stripes extending in the thickness direction in the outer circumferential edge surfaces 12 and/or the inner circumferential edge surfaces 13. Each stripe had a width of about 1 to 10 μm in a circumferential direction.

### Experiment 4

Glass substrates for magnetic disks having an outer diameter of 97 mm, an inner diameter of 25 mm, and a thickness of 0.5 mm were obtained in Examples 10 to 12 by successively performing the edge surface grinding step, the edge surface polishing step, the main surface grinding step, and the main surface polishing step described above on the annular glass substrates 1 obtained in Examples 7 to 9, respectively. Note that a total allowance in the edge surface grinding step and the edge surface polishing step was set to 500 μm in terms of radius for both the outer diameter and the inner diameter to perform the following steps in a state where the flattened regions were not left in the main surface 11a. In none of the three glass substrates for magnetic disks, chipped portions or the like were observed in the outer circumferential edge surface 12 and the inner circumferential edge surface 13.

In Reference Example 1, the annular glass substrate 1 obtained in Example 8 was used, a total allowance in the edge surface grinding step and the edge surface polishing step was set to 300 μm in terms of radius for the outer diameter to perform the following steps in a state where a flattened region was left in the main surface 11a. A glass substrate for a magnetic disk having an outer diameter of 97.4 mm, an inner diameter of 25 mm, and a thickness of 0.5 mm was obtained in the same manner as in Example 11 described above, other than the above-described change. The obtained glass substrate for a magnetic disk included a chipped portion in the outer circumferential edge surface 12. This is presumably because the main surface 11a was ground and polished in a state where there was residual stress in a portion of the main surface 11a in the vicinity of the outer circumferential edge surface 12, and therefore, chipping occurred due to a load applied from a surface plate or contact between the main surface and a carrier. From these results, it was found the occurrence of chipping in the steps following the edge surface grinding and the edge surface polishing can be suppressed when flattened regions are completely removed in the edge surface grinding and the edge surface polishing.

### Variations

Although an embodiment of the present invention has been described, the present invention is not limited to the above embodiment, and various changes can be made within the scope of the claims. The following describes variations of the above embodiment.

In the above embodiment, the inner scribe line formation step (S30) is performed after the first separation step (S20), but there is no limitation to this configuration. For example, the inner scribe line formation step (S30) may be performed after the outer scribe line formation step (S10) and before the first separation step (S20). The inner scribe line formation step (S30) may also be performed before the outer scribe line formation step (S10). Alternatively, the outer scribe line D1 and the inner scribe line D2 may be formed at the same time by performing the outer scribe line formation step (S10) and the inner scribe line formation step (S30) at the same time. In this case, the outer to-be-scribed line C1 and the inner to-be-scribed line C2 are irradiated with the first laser beam L1 at the same time in the flattening step. Then, the outer to-be-scribed region R1 and the inner to-be-scribed region R2 are irradiated with the second laser beam L2 at the same time in the scribe line formation step.

In the above embodiment, irradiation with the laser beams L1 and L2 is performed in the outer scribe line formation step (S10) and the inner scribe line formation step (S30) in the state where irradiation positions of the laser beams L1 and L2 are fixed and the glass blank on the stage T is rotated by rotating the stage T at a constant speed, but there is no limitation to this configuration. For example, it is also possible to move a laser beam L while irradiating the glass blank fixed on the stage T with the laser beam L by driving an optical system such as a micro mirror device provided in the laser beam source and optical system 30 to periodically deflect the light beam.

In the above embodiment, a plurality of defects are formed in the counterclockwise direction along the outer to-be-scribed line C1 and the inner to-be-scribed line C2 in the outer scribe line formation step (S10) and the inner scribe line formation step (S30), but the defects may also be formed in the clockwise direction along the outer to-be-scribed line C1 and the inner to-be-scribed line C2.

In a case where the surface of the glass blank 20 has been peeled through irradiation with the first laser beam L1 in the flattening step (S10a, S30a), the manufacturing method may include a step for removing peeled fragments before the scribe line formation step (S10b, S30b). For example, at least a portion of peeled fragments may remain on the surface of the glass blank 20 as a result of fragments that were once peeled off from the surface of the glass blank 20 falling onto the surface of the glass blank 20 or a portion of the irradiated region not being completely peeled from the surface of the glass blank 20. If there are peeled fragments on the outer to-be-scribed region R1 or the inner to-be-scribed region R2 during irradiation with the second laser beam L2, the scribe line D1 or D2 may not be formed. The peeled fragments can be removed by being blown off with air or swept with a brush, for example. In the case where the outer to-be-scribed region R1 and/or the inner to-be-scribed region R2 has been peeled through irradiation with the first laser beam L1, there is a circular groove in the outer to-be-scribed region R1 and/or the inner to-be-scribed region R2. Such a circular groove has an effect of promoting separation in the first separation step (S20) or the second separation step (S40) together with the outer scribe line D1 or the inner scribe line D2 formed in the scribe line formation step (S10b, S30b). On the other hand, the larger the glass substrate to be separated and taken out is and the longer the scribe line is, the more likely it is that fragments that were once peeled off from the surface of the glass blank 20 remain in the groove, which may increase the risk of the scribe line D1 or D2 not being formed in a portion of the to-be-scribed region through irradiation with the second laser beam L2.

In the above embodiment, the flattening step (S10a, S30a) is performed by irradiating the surface of the glass blank 20 with the first laser beam L1, but the flattening step may be performed using other methods. For example, the flattening step may be performed to reduce the surface roughness Ra to 0.2 μm or less by polishing an entire surface of the glass blank 20 on which a scribe line is to be formed, similarly to main surface polishing processing commonly performed on substrates. Alternatively, the flattening step may also be performed by polishing only a portion of the main surface 11a including at least the to-be-scribed line C1 or C2. In the case where the to-be-scribed line C1 or C2 has a circular shape, it is possible to polish only a surrounding region of the to-be-scribed line C1 or C2 by pressing a cylindrical jig provided with a circular polishing pad at an end portion thereof against the glass blank 20 while rotating the jig about a central axis and supplying a polishing liquid, for example.

In the above embodiment, steps from the outer scribe line formation step (S10) to the second separation step (S40) are described, but the manufacturing method may include a preprocessing step before the outer scribe line formation step (S10) or a postprocessing step after the second separation step (S40). For example, chamfering may be performed on the outer circumferential edge surface 12 and/or the inner circumferential edge surface 13 of the annular glass substrate 1 after the second separation step (S40) by using the first laser beam L1 used in the flattening step (S10a, S30a).

In the above embodiment, the heaters 40 are disposed outside the scribe lines D1 and D2 and are not disposed inside the scribe lines D1 and D2 in the first separation step (S20) and the second separation step (S40), but there is no limitation to this configuration. As long as the portions outside the scribe lines D1 and D2 can be heated at a temperature higher than the temperature of the portions inside the scribe lines D1 and D2, heaters may be disposed inside the scribe lines D1 and D2 to heat the portions inside the scribe lines D1 and D2.

In the above embodiment, the annular glass substrate, which is an example of a disk-shaped glass substrate, is used for a magnetic disk, but there is no limitation to this example, and the disk-shaped glass substrate can be used in suitable applications. For example, a disk-shaped glass substrate that does not include an inner hole (inner circumferential circle) can be used for a semiconductor. The disk-shaped glass substrate not including an inner hole can be manufactured by performing a postprocessing step after the outer scribe line formation step (S10) and the first separation step (S20) of the above embodiment, without the inner scribe line formation step (S30) and the second separation step (S40) being performed.

1. A method for manufacturing a glass substrate, comprising:
flattening a to-be-scribed region extending along a predetermined to-be-scribed line on a surface of a glass blank by irradiating the surface of the glass blank with a first laser beam along the to-be-scribed line; and
forming a scribe line along the to-be-scribed line by irradiating the flattened to-be-scribed region with a second laser beam.

2. The method for manufacturing a glass substrate according to claim 1,
wherein the to-be-scribed region is flattened so as to have a surface roughness Ra of 0.2 μm or less.

3. The method for manufacturing a glass substrate according to claim 1,
wherein a surface roughness Ra of the surface of the glass blank prior to being irradiated with the first laser beam is larger than 0.2 μm.

4. The method for manufacturing a glass substrate according to claim 1,
wherein the to-be-scribed region is melted or peeled as a result of being irradiated with the first laser beam.

5. The method for manufacturing a glass substrate according to claim 1,
wherein the to-be-scribed line forms a circle.

6. The method for manufacturing a glass substrate according to claim 1, further comprising
heating a portion outside the scribe line on the glass blank, on which the scribe line has been formed, at a temperature higher than a temperature of a portion inside the scribe line to separate the portion outside the scribe line from the portion inside the scribe line.

7. The method for manufacturing a glass substrate according to claim 6,
wherein a glass substrate obtained by separating the portion outside the scribe line from the portion inside the scribe line has two main surfaces and an outer circumferential edge surface,
an outer circumferential edge portion of one of the main surfaces includes a flattened region formed through irradiation with the first laser beam, and
the flattened region is completely removed by grinding and/or polishing the outer circumferential edge surface of the glass substrate.

8. A method for manufacturing a glass substrate, comprising:
preparing a glass blank:
flattening a portion of a main surface of the glass blank including at least a to-be-scribed line to reduce a surface roughness Ra; and
irradiating the flattened surface with a laser beam to form a scribe line.

9. The method for manufacturing a glass substrate according to claim 1,
wherein the glass blank has a main surface that has a surface roughness Ra larger than 0.2 μm, and
a portion of the main surface is flattened so as to have a surface roughness Ra of 0.2 μm or less.

10. The method for manufacturing a glass substrate according to claim 1,
wherein the glass substrate is a glass substrate for a magnetic disk.

11. A disk-shaped glass substrate comprising:
two main surfaces,
wherein an outer circumferential edge portion of at least one main surface of the two main surfaces includes a flattened region that has a smaller surface roughness Ra than another region of the main surface, and
the flattened region has a width of 5 mm or less in a radial direction and a height within a range from −0.3 to +0.3 mm with respect to the other region of the main surface of the glass substrate.

12. The disk-shaped glass substrate according to claim 11,
wherein the flattened region has a surface roughness Ra of 0.2 μm or less, and
the other region of the main surface has a surface roughness Ra larger than 0.2 μm.

13. The disk-shaped glass substrate according to claim 11,
wherein there is a plurality of linear stripes extending in a thickness direction in an outer circumferential edge surface of the glass substrate.

14. The disk-shaped glass substrate according to claim 11, further comprising:
a circular inner hole; and
a flattened region extending along an outer edge of the inner hole in one of the two main surfaces.
